(19) United States
(12) Patent Application Publication
(10) Pub. No.: US 2010/0232504 A1
(43) Pub. Date: Sep. 16, 2010

(54) Supporting region-of-interest cropping through constrained compression

(75) Inventor: Wu-chi Feng, Tigard, OR (US)

Correspondence Address: LUMEN PATENT FIRM, 350 Cambridge Avenue, Suite 100, PALO ALTO, CA, 94306, US

(73) Assignees: The State of Oregon acting by and through the State Board of Higher Education on Behalf of the; Portland State University

(21) Appl. No.: 12/661,262

(22) Filed: Mar. 11, 2010

Related U.S. Application Data
(60) Provisional application No. 61/210,090, filed on Mar. 13, 2009.

(51) Int. Cl. H04N 7/32

(52) U.S. Cl. 375/240.13; 375/E07.243

(57) ABSTRACT

Region-of-interest cropping of high-resolution video is supported video compression and extraction methods. The compression method divides each frame into virtual tiles, each containing a rectangular array of macroblocks. Intra-frame compression uses constrained motion estimation to ensure that no macroblock references data beyond the edge of a tile. Extra slice headers are included on the left side of every macroblock row in the tiles to permit access to macroblocks on the left edge of each tile during extraction. The compression method may also include breaking skipped macroblock runs into multiple smaller skipped macroblock runs. The extraction method removes slices from virtual tiles that intersect the region-of-interest to produce cropped frames. The cropped digital video stream and the compressed digital video stream have the same video sequence header information.

### CROSS-REFERENCE TO RELATED APPLICATIONS

This application claims priority from U.S. Provisional Patent Application 61/210,090 filed Mar. 13, 2009, which is incorporated herein by reference.

### STATEMENT OF GOVERNMENT SPONSORED SUPPORT

This invention was made with Government support under contract CNS-0722063 awarded by NSF. The Government has certain rights in this invention.

### FIELD OF THE INVENTION

This invention relates generally to image processing techniques. More specifically, it relates to techniques for region-of-interest cropping of compressed video image streams.

### BACKGROUND OF THE INVENTION

High resolution digital video is quickly becoming pervasive. It is used in high-definition video distribution and also is finding increasing use in the motion picture industry. While creating such high resolution video is becoming easier, there is a need for techniques that allow scaling of the video to a particular display resolution and cropping the region-of-interest of the user. For the former, several techniques have been proposed and implemented to allow users to easily scale the resolution of video. Furthermore, approaches have been proposed to help optimize the bit-rate and quality delivery over a wider range of device resolutions. For region-of-interest (ROI) cropping, however, generating a video stream from a high-resolution compressed stream is difficult due to the fact that digital video is normally delivered in a compressed format that does not support cropping. Cropping can be performed by decompressing, cropping, and recompressing, but this brute-force approach is computationally expensive, especially for high-resolution video, and it also reduces image quality.

To fully appreciate the challenges of ROI cropping, it is helpful to review the details for compressing digital video streams. Various standards have been developed for video compression, including H.263, H.264, MPEG-1, MPEG-2, and MPEG-4. For the sake of definiteness, we will focus on a common standard, MPEG-2. The MPEG-2 standard specifies a general coding for compressed digital video (and associated sound). MPEG-2 is widely used for digital television (DTV) as well as digital video discs (DVD). Uncompressed digital video is composed of a temporal sequence of frames, where each frame is a still picture composed of an array of image pixels. In DCT-based compression algorithms such as MPEG-2, the pixels are grouped into macroblocks, where each macroblock contains a 16×16 set of pixels. For example, FIG. 3A illustrates a single frame 300. Region 308 of the frame contains macroblocks such as macroblock 306 which contains a 16×16 array of pixels such as pixel 310.

MPEG-2 combines two primary video compression techniques, intra-frame compression and inter-frame compression. Intra-frame compression independently compresses each individual macroblock 306 of each frame 300. Specifically, a discrete cosine transform (DCT) is used to convert the array of 16×16 image pixels of a macroblock 306 to quantized frequency domain coefficients. Because the array of pixels in the original macroblock often will have low spatial frequency, the higher frequency coefficients will often be zero, allowing considerable compression of the coefficients. By reversing this process, the 16×16 array of image pixels of the macroblock can be recovered, with some loss of detail. In short, intra-frame compression takes advantage of spatial redundancy localized within a single macroblock of a single frame.

With inter-frame compression, MPEG-2 also takes advantage of temporal redundancy between nearby video frames. Because many macroblocks in a sequence of frames do not change significantly from one frame to the next, or are uniformly shifted, a sequence of video frames can be temporally compressed by combining occasional intra-coded frames (I-frames) with predictive-coded frames (P-frames) and bidirectionally-predictive-coded frames (B-frames). The I-frames are spatially compressed using intra-frame compression but are otherwise self-contained and can be decompressed without information from other video frames. In contrast, P-frames can compress further by storing the difference information needed to reconstruct macroblocks in the frame from previous I-frames, and B-frames can compress even further yet by storing the difference information needed to reconstruct macroblocks in the frame from previous and following I-frames or P-frames.

The difference information is generated by a motion compensation technique. For each macroblock, a search of neighboring macroblocks in one or more reference frames is performed to find a close match to be used as a prediction. If a suitable match is found, the offset can be encoded as a motion vector or skipped completely if there is no offset. If no match is found, the macroblock data is included. It is important to note that the standard does not specify how the motion compensation is to be accomplished. The specific motion-estimation range and the specific way motion-compensation is accomplished is up to the encoder.

In order to provide some error resiliency, MPEG video streams use the notion of slices, which encapsulate a number of sequential (scan order) macroblocks. The slice is used as a way to restart decompression upon an error (e.g., bit flip) in the video stream. For MPEG-2, the standard specifies a slice per macroblock row in the frame. While slices allow for error recovery, they are not completely self contained. Motion vectors that reference data in other slices are entirely possible, and necessary, in order to achieve higher compression ratios.

U.S. Pat. No. 6,959,045, which is incorporated herein by reference, discloses a technique for decoding digital video to a size less than the full size of the pictures by trimming data from the outermost edges of a video prior to decoding. The technique parses the video to identify macroblocks, discards macroblocks not associated with a picture region, and stores the resulting video data in a decoder input buffer. Although this technique involves cropping to trim the outermost edges in a fixed manner for display, it does not support efficient cropping of a video stream to an arbitrary region-of-interest that has an adjustable size and position. This technique also has the problem that it discards macroblocks in I-frames that may be required for prediction of macroblocks in P-frames and B-frames, thus resulting in decoding artifacts.

U.S. Pat. No. 7,437,007, which is incorporated herein by reference, discloses a technique for performing region-of-interest editing of a video stream in the compressed domain. Two primary techniques are used. First, they delete DCT coefficients that are not in (or proximate to) the ROI. Second, for P-frames and B-frames, all macroblocks except the first and the last in a slice that is completely above or below the ROI are recoded into a skipped macroblock run. To prevent corruption of data due to inter-frame predictive encoding, they preserve data in a guard ring proximate to the ROI. The guard ring is a predetermined fixed width around the ROI or is determined dynamically. The modified video is then encoded using standard encoding techniques. Note that the video is assumed to use a standard encoding both before and after the technique. This technique, however, requires that the stream be parsed, causing it to be slower and less scalable than desired. In addition, it has problems with some videos that are encoded with one slice per frame.

### SUMMARY OF THE INVENTION

The present invention provides new techniques to support efficient, real-time (or faster) region-of-interest cropping of compressed, high-resolution video streams. A video stream is compressed to provide a light-weight mechanism to support real-time region-of-interest (ROI) cropping of super-high resolution video. The technique employs a new coding and extraction mechanism for supporting efficient cropping of a video stream to an arbitrary region-of-interest that has an adjustable size and position in real time. The method may be applied to video streams that are compressed using any of a variety of DCT-based standards such H.263, H.264, MPEG-1, MPEG-2, and MPEG-4.

In one aspect, a computer-implemented method is provided for compressing a digital video stream to support real-time region-of-interest cropping. The method includes dividing each frame of the digital video stream into contiguous, non-overlapping macroblocks, each of which contains a set of 16×16 pixels. Additionally, each frame is also divided into contiguous, non-overlapping virtual tiles, each of which contains a set of multiple macroblocks. Each of the virtual tiles contains a set of N×M macroblocks. Preferably, N and M each may range from 4 to 100. In one embodiment, the tiles are squares (i.e., N=M). In another embodiment, each frame is divided into a set of 4×4 rectangular tiles. In some embodiments, a custom tiling is used with different sized tiles. For example, in one embodiment designed for efficiently cropping HDTV down to NTSC, one virtual tile is positioned in the middle and two virtual tiles the left and right.

The compression technique also includes performing intra-frame compression of the digital video stream using constrained motion estimation to ensure that no macroblock in the tile references data beyond the edge of the tile. Additionally, it includes performing inter-frame compression of the digital video stream by separately compressing each of the macroblocks in each frame using a discrete cosine transform. A compressed video stream is generated from results of the inter-frame compression and intra-frame compression. The compressed video stream may include extra slice headers on the left side of every macroblock row in each of the virtual tiles to permit access to macroblocks on the left edge of each tile. The compression method may also include breaking skipped macroblock runs into multiple smaller skipped macroblock runs.

In another aspect, the invention also provides a computer-implemented method for extracting in real time (or faster than real time) a region-of-interest from a compressed digital video stream. The method includes dividing each frame of the compressed digital video stream into macroblocks, each of which represents a compressed 16×16 array of pixels. Each of the virtual tiles contains a set of N×M macroblocks. Preferably, N and M each may range from 4 to 100. In one embodiment, the tiles are squares (i.e., N=M). In another embodiment, each frame is divided into a set of 4×4 rectangular tiles. Additionally, each frame is divided into virtual tiles, each of which contains a set of multiple macroblocks. The extraction method also includes removing slices from virtual tiles that do not intersect the region-of-interest to produce cropped frames and generating a cropped digital video stream from the cropped frames. The cropped digital video stream and the compressed digital video stream have the same video sequence header information.

### BRIEF DESCRIPTION OF THE DRAWINGS

FIG. 1 is a flowchart outlining steps of a method for compressing a video stream to support region-of-interest cropping, according to an embodiment of the invention.

FIG. 2 is a flowchart outlining steps of a method for extracting a region-of-interest of a video stream, according to an embodiment of the invention.

FIG. 3A is a schematic diagram illustrating how a video frame is divided into macroblocks and pixels, according to conventional compression techniques.

FIG. 3B is a schematic diagram illustrating how a video frame is divided into tiles composed of macroblocks and slice headers, according to an embodiment of the invention.

FIG. 4 is a schematic diagram illustrating how a sequence of video frames divided into tiles are cropped to a region-of-interest to produce a new sequence of video frames, according to an embodiment of the invention.

### DETAILED DESCRIPTION

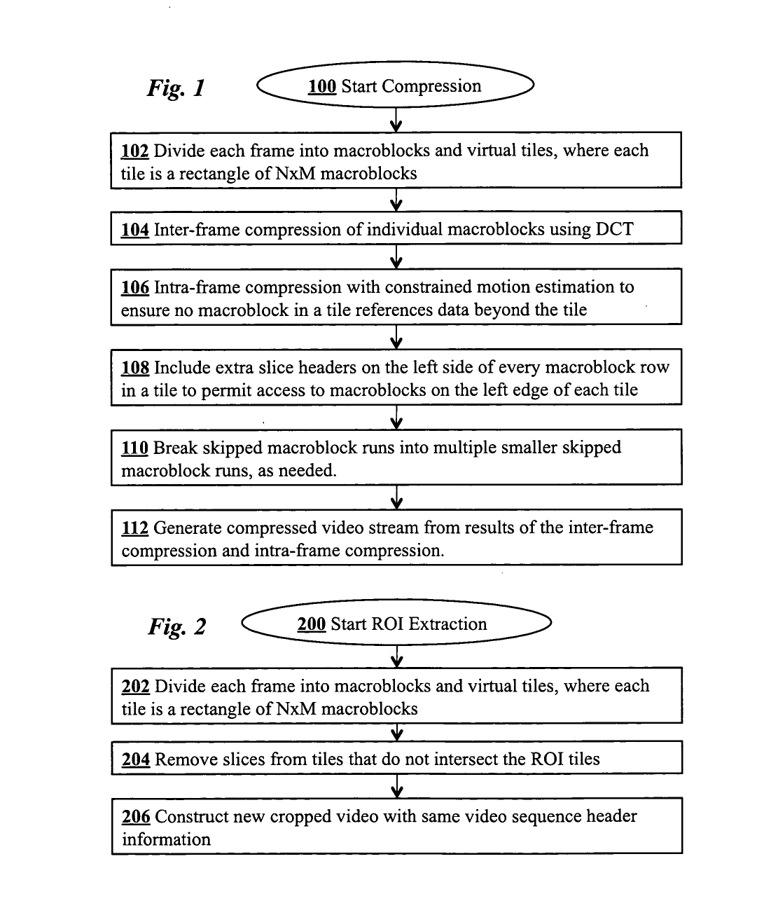

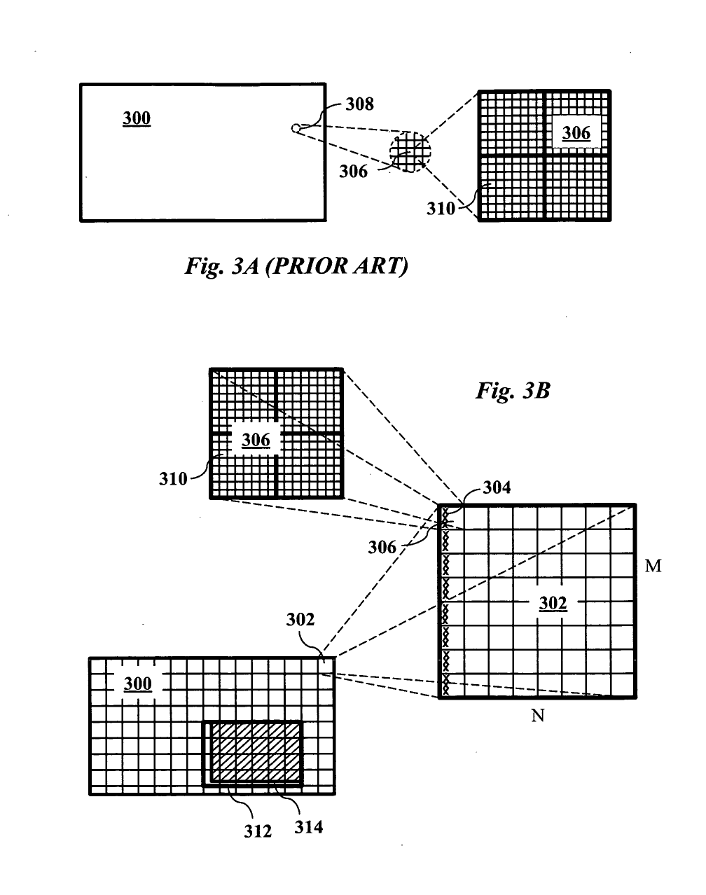

Steps of a preferred embodiment of an encoding technique are shown in FIG. 1. The technique encodes a video stream such that the resulting stream supports efficient region-of-interest cropping. The compression begins at step 100 and presupposes a sequence of video frames are provided. In step 102, each frame of the video sequence is divided into macroblocks, as is customary in standard MPEG-2 encoding. For high definition, for example, the frame will have 120 macroblocks across, i.e., 1920 pixels across. Unlike conventional MPEG-2 encoding, however, the frame is also divided into virtual tiles, each of which is a set of multiple contiguous macroblocks arranged in a rectangular array. FIG. 3B illustrates an example of a high definition (HD) frame 300 which is divided into an array of tiles, such as tile 302. A typical tile such as tile 302 is an array of N×M macroblocks 306, and each macroblock 306 is an array of 16×16 pixels (e.g., pixel 310). The tiling structure is one of the features of the encoding that enables efficient region-of-interest cropping, as will be explained in detail later.

Typically, all or most all of the tiles in a frame all have a common size (i.e., common values for N and M), although some tiles near one or more edges of the frame may have a different size. In the example shown in FIG. 3B, tile 302 is an array of 8×8 macroblocks 306. With this size, tile 302 is 128 pixels across, and the frame is 15 tiles across. Alternative tile sizes may also be used (i.e., different values for N and M). For example, frame 300 could be divided so there are 5 tiles across, where each tile is 24 macroblocks across, i.e., 384 pixels across. For super-high resolution video, each frame typically is at least 256 macroblocks across (i.e., more than 4000 pixels). Thus, dividing this size frame into 4 tiles across would result in each tile having more than 1000 pixels across, or 64 macroblocks across. In some cases, it may be preferable to divide the frame into a larger number of smaller-sized tiles. For example, with tiles 4 macroblocks across, the frame for a super high resolution video would be divided into over 1000 tiles across. More generally, N and M each may range from 4 to 100. In preferred embodiments, the tiles are squares (i.e., N=M) or rectangles with an aspect ratio no larger than 2.

Returning now to FIG. 1, step 104 of the compression method includes performing inter-frame compression of the digital video stream by separately compressing each of the macroblocks in each frame using a discrete cosine transform (DCT). This step preferably uses any of the techniques commonly known in the art of MPEG-2 compression.

Step 106 of the compression technique includes performing intra-frame compression of the digital video stream using constrained motion estimation to ensure that no macroblock in the tile references data beyond the edge of the tile. In other words, this ensures that the tiles are self-contained. In conventional MPEG-2 encoding, motion estimation is not constrained, resulting in decoding artifacts if the frame is cropped. In contrast, the constrained motion estimation technique in step 106 restricts motion estimation for a macroblock to the tile that the macroblock belongs to. In other words, during the motion estimation search, a macroblock is not allowed to reference another macroblock beyond the edge of the tile. This means that the macroblocks along the edge of the tiles will not have as many choices for prediction, thus limiting the quality of matches available. Consequently, it is preferable that the tile size be at least 4 macroblocks across and 4 macroblocks tall, and more preferable that the tile size is larger yet, e.g., 30 macroblocks wide and tall.

In step 108 extra slice headers are added to the left side of every macroblock row in each of the virtual tiles to permit access to macroblocks on the left edge of each tile. Adding an extra slice header at the left side of every macro block row in a tile allows us to store the “startup” information within the file itself. FIG. 3B illustrates slice headers (indicated by “x” marks) in the leftmost macroblock of each row of the tile. For example, a slide header 304 is stored for leftmost macroblock 306 in the top row of tile 302. In an alternative embodiment, rather than slice headers, an index file can be used that points to where the macroblocks on the right side of the tiles begin. Sufficient data can be saved in the index file (e.g., last DC value) so that decompression can begin.

In the compression, there are two primary components to the overhead: (i) the overhead of limiting motion-estimation and (ii) introducing slice headers. The overhead of the motion-estimation is negligible for tile widths of 30 macroblocks and above. In terms of slice header overhead, as the tile width goes to 30 macroblocks, the overhead of the slices goes away in relation to the video file size. Thus, in some embodiments it is preferable to have tiles with widths of at least 30 macroblocks.

In order to allow a region-of-interest to be extracted, the encoding method enables access macroblocks that are on the left edge of a particular tile. Of primary concern are skipped macroblock runs that span across the boundaries of the tiles. To handle such situations, in step 110, all skipped macroblock runs are broken into multiple smaller skipped macroblock runs. Specifically, if a skipped macroblock run spans the boundary of a tile, it can be broken at the tile boundary into two smaller skipped macroblock runs.

In step 112, a compressed video stream is generated from the results of the above processing steps. The result of this compression algorithm an encoded video stream that is completely compliant with the MPEG-2 video stream. Thus, any MPEG-2 video player can play it. More importantly, however, the encoded video stream supports efficient region-of-interest cropping, as will become evident below in the description of the video extraction method.

The main steps in a preferred embodiment of a method for extracting a region-of-interest from a compressed video stream in real time is shown in FIG. 2. To retrieve a smaller region-of-interest from the video, a smallest group of tiles covering the region-of-interest is identified, extracted, and made into a video stream. In some embodiments, slices outside the region-of-interest (above and below) can be removed as well. The extraction method begins with step 200 which assumes a compressed video stream is provided. Step 202 of the method includes dividing each frame of the compressed digital video stream into a set of multiple virtual tiles, each of which contains a set of N×M macroblocks. Each of the macroblocks is an encoded representation of a compressed 16×16 array of pixels. Thus, the division of the video stream into macroblocks is implicit in the encoding of the compressed digital video stream, so division of a frame into macroblocks amounts to recognizing the encoded macroblocks in the frame. As with the encoding, N and M each may range from 4 to 100.

In step 204, the extraction method also includes removing slices from virtual tiles that intersect a specified region-of-interest to produce cropped frames. The extraction method thus requires that the region-of-interest information be specified. A simple parser can be used to scan through the video sequence and remove the slices that correspond to tiles being removed. Because all slice headers are byte aligned, this process requires one pass through the file with little other additional processing, assuming the width of the tile is known a priori. Alternatively, tiles could be extracted from the compressed video stream using an index file that contains the positions of all header information and slices within a video stream. Extraction would then look through the index file and extract the relevant parts of the stream.

For parsing the video stream on-the-fly, we do not need to decompress any of the stream. However, the stream is searched through byte-by-byte to find out the location of the slice headers. We assume that the stream has been properly formatted with slices at the left side of each tile's macroblock rows. Given this assumption, the parser determines which slice numbers to remove and simply copies them, in addition to important headers like the sequence, GOP, and picture, to the output stream. This can be accomplished on the fly at real time frame rates. Although indexing improves extraction speed for normal resolution video, for high resolution video the improvement may not be significant depending on the time reading and writing from the disk due to the larger amount of extracted data. For the extraction of a ROI from a compressed video stream using realistic compression number (i.e., quantization factors greater than 10), the regions can be extracted at several thousand frames per second regardless of the use of an index file. Thus, extraction is quite reasonable and scalable.

In step 206, a cropped digital video stream is generated from the cropped frames. In the preferred embodiment, the cropped digital video stream and the compressed digital video stream have the same video sequence header information. That is, all headers in the original stream are left alone while slices that do not belong to tiles covering the region-of-interest are removed. In effect, this generates a video stream with the same resolution as the original but with “missing” data. The chief advantage of this approach is that it is efficient to support the ROI extraction because sequence headers do not need to be modified, particularly when the ROI area size changes over time. This also makes it easier to implement the application so that it does not need to continually deal with changing video sizes and the location within the original stream. Alternatively, one could set the video stream to the size of the tiles encompassing the region-of-interest, but that would require that the sequence header be modified to adjust the video resolution and possibly the aspect ratio. Furthermore, new sequence headers may need to be created. In addition, the slice offsets would need to be adjusted to reflect their new position within the video frame. One implication of adjusting the headers is that the ROI size needs to stay within the bounds of the set of tiles that is encoded in the sequence header. If the ROI size went beyond these bounds, then a new sequence header and GOP header may need to be generated on-the-fly to allow the video to be resized. Accordingly, it is preferred not to modify the header information.

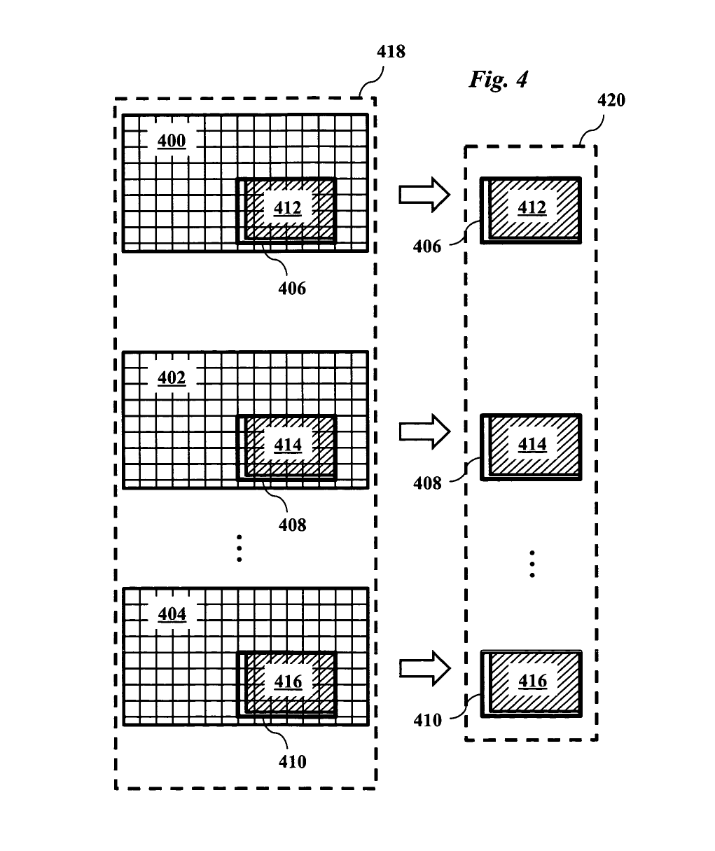

FIG. 4 is a schematic diagram illustrating the extraction of a cropped video stream from an original video stream according to an embodiment of the invention. Video frames 400, 402, 404 are the first, second, and last frames of a full-resolution original video stream 418 encoded using the encoding techniques described above in relation to FIG. 1. Regions-of-interest 412, 414, 416, are specified for each of the frames 400, 402, 404, respectively. Although these regions are illustrated for simplicity as having the same size and position in their respective frames, in general the sizes and positions of regions-of-interest may differ from frame to frame, e.g., as a user or video processor dynamically moves the region-of-interest position and/or changes the region-of-interest size in real time. Corresponding to the specified regions-of-interest 412, 414, 416 are extracted tile regions 406, 408, 410, respectively. The extracted tile region corresponding to a region-of-interest is defined as the smallest group of tiles needed to completely cover the specified region-of-interest. For example, the tile region 406 completely covers region-of-interest 412 but contains only tiles that intersect the region-of-interest 412, and no more. The region-of-interest may be specified by providing its size and position in macroblock units. Using the extraction techniques described above in relation to FIG. 2, a cropped video stream 420 is generated from the full-size video stream 418. The cropped video stream includes the extracted tile regions 406, 408, 410 which cover the regions-of-interest 412, 414, 416, respectively. The image information in the frames 400, 402, 404 that is outsize of the extracted tile regions 406, 408, 410 is removed during extraction. The resulting video stream 420 is generated from these extracted tile regions and can be played by any standard MPEG-2 player. Because this technique extracts tile regions, the extracted video will usually extend slightly beyond the specified region-of-interest. This has two primary benefits. First, the use of tiles avoids the need to re-encode the video which can reduce the video quality. Second, the use of tiles provides some extra area for the user to move the ROI around without requiring the system to make fine-grained adaptation.

In order to support scaling, panning, and zooming of video the techniques of the present invention can be combined with scalable encoding and resolution adaptation mechanisms. Resolution adaptation can be implemented using a hierarchical resolution adaptation mechanism. For example, a video stream can be stored at several key resolutions and the resolution adaptation is accomplished from the nearest resolution. This approach reduces the bandwidth and storage requirements while increasing the quality of the video data. For region-of-interest adaptation, the proposed ROI approach can be applied to each of the layers in the scalable video delivery mechanism. This will allow for zooming and cropping within a particular resolution layer and will allow scaling via the multiple layers.

The compression and decompression techniques of the present invention may be implemented in software or hardware following the practices and principles commonly known in the art and widely used for other MPEG-2 encoders and decoders. Standard encoders and decoders can be modified by those skilled in the art using the teachings of the present invention to implement ROI compression and extraction in computational devices.

These techniques for supporting ROI cropping will become increasingly important as super high-resolution video processing becomes more common. For panoramic video surveillance video, for example, only a small region within the video is often of interest to the user at a time. For the high-resolution video data, ROI cropping may be needed to change the aspect ratio of the video from HDTV (16:9) to NTSC (4:3). Further, the footage may be used as input into a production process that may require a cropped region for the final view.

A video stream may be captured and stored, for example, using a single camera or stitching together video from several cameras. The technique may be implemented using a high-resolution digital video camera and a computer with a processor and memory. Compressed images may be stored on a digital storage medium, transmitted, and decompressed at a later time for viewing on a video display. The methods described herein may also be realized as a digital storage medium tangibly embodying machine-readable instructions executable by a computer.

1. A computer-implemented method for compressing a digital video stream to support region-of-interest cropping, the method comprising:
dividing each frame of the digital video stream into macroblocks, wherein each of the macroblocks contains a set of 16×16 pixels;
dividing each frame into virtual tiles, wherein each of the virtual tiles contains a set of multiple macroblocks;
performing intra-frame compression of the digital video stream using constrained motion estimation to ensure that no macroblock in the tile references data beyond the edge of the tile;
performing inter-frame compression of the digital video stream by separately compressing each of the macroblocks in each frame using a discrete cosine transform;
and
generating a compressed video stream from results of the inter-frame compression and intra-frame compression.

2. The method of claim 1 wherein each of the virtual tiles contains a set of N×M macroblocks, where 4≦N≦100 and 4≦M≦100.

3. The method of claim 2 wherein N is at least 30 and M is at least 30.

4. The method of claim 1 wherein the tiles are rectangles with an aspect ratio no larger than 2.

5. The method of claim 1 wherein each frame is divided into a set of 4×4 virtual tiles.

6. The method of claim 1 wherein the compressed video stream includes extra slice headers on the left side of every macroblock row in each of the virtual tiles to permit access to macroblocks on the left edge of each tile.

7. The method of claim 1 further comprising breaking skipped macroblock runs into multiple smaller skipped macroblock runs.

8. A computer-implemented method for extracting a region-of-interest from a compressed digital video stream, the method comprising:
dividing each frame of the compressed digital video stream into macroblocks, wherein each of the macroblocks represents compressed 16×16 pixels;
dividing each frame of the compressed digital video stream into virtual tiles, wherein each of the virtual tiles contains a set of multiple macroblocks;
removing slices from virtual tiles that do not intersect the region-of-interest to produce cropped frames;
generating a cropped digital video stream from the cropped frames, wherein the cropped digital video stream and the compressed digital video stream have the same video sequence header information.

9. The method of claim 8 wherein each of the virtual tiles contains a set of N×M macroblocks, where 4≦N≦100 and 4≦M≦100.

10. The method of claim 9 wherein N is at least 30 and M is at least 30.

11. The method of claim 8 wherein the tiles are rectangles with an aspect ratio no larger than 2.

12. The method of claim 8 wherein each frame is divided into a set of 4×4 virtual tiles.
